(19) United States
(12) Patent Application Publication
(10) Pub. No.: US 2024/0369822 A1
(43) Pub. Date: Nov. 7, 2024

(54) DIGITAL NIGHT VISION SYSTEM

(71) Applicant: GALVION LTD., Portsmouth, NH (US)

(72) Inventor: Christopher MOORE, Dundry (GB)

(73) Assignee: GALVION LTD., Portsmouth, NH (US)

(21) Appl. No.: 18/654,788

(22) Filed: May 3, 2024

Related U.S. Application Data
(60) Provisional application No. 63/500,386, filed on May 5, 2023.

(51) Int. Cl. G02B 23/12; G02B 23/18; G06T 11/00; H01J 31/50; H04N 23/63; H04N 25/76; H04N 25/78

(52) U.S. Cl. CPC G02B 23/125; G02B 23/18; G06T 11/001; H01J 31/507; H04N 23/63; H04N 25/7795; H04N 25/78; H01J 2231/50068

(57) ABSTRACT

A digital night vision device includes an image sensor that generates digital image data based on an enhanced version of a low light image and a digital display device that generates an image based on the digital image data. The image sensor is configured to output the digital image data formatted as input display data such that pass-through electronics for communicating digital image data from the image sensor to the digital display device does not perform formatting or conversion of the digital image data when moving the digital image data from the sensor to the display.

### 1 CROSS REFERENCE TO RELATED U.S. PATENT APPLICATIONS

The present application claims priority under 35 U.S.C. § 119 (e) to provisional U.S. Patent Application Ser. No. 63/500,386 filed May 5, 2023, which is incorporated herein by reference in its entirety and for all purposes.

### 2 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2022-2024, Galvion, Ltd, Portsmouth, NH.

### 3 BACKGROUND OF THE INVENTION

### 3.1 Field of the Invention

The subject disclosure is directed to digital night vision devices, and more particularly to systems, software, and methods for enhancing low-light images for viewing through one or more eyepieces.

### 3.2 The Related Art

Known systems include an image intensifier tube that can enhance a low light image by converting photons to electrons, accelerating and multiplying the electrons, and then converting the accelerated and multiplied electrons to photons, thus generating an enhanced version of the low light image. The enhanced version of the low light image may be viewed directly by a user and, in the case of digital night vision systems, is projected onto an image sensor. In known systems the image sensor generates digital sensor output data representing the enhanced version of the low light image. The enhanced version is processed by one or more digital data processors to process the digital sensor output data, including reformatting the data, applying corrective algorithms, and the like to generate data formatted for use by a particular display device to generate an image.

### 4 SUMMARY OF THE INVENTION

One problem with conventional systems is that the image processing operation on digital sensor output data carried out by digital data processors introduces latency, or a lag in timing between when a system views a low light image and when an enhanced version of the low light image is displayed. This is problematic because a user is provided with an image of a scene from a previous time point. Latency can be especially problematic when the user, or an object being visualized, is moving since the user or the object is not in the same place when viewed by the user as when the system acquired the image. The inventors have recognized that eliminating most or all processing of digital sensor output data will reduce latency, thereby providing an improved user experience.

The inventors have further recognized that a novel imaging sensor according to the technology herein, for example a novel complementary metal-oxide semiconductor (CMOS) sensor, can generate output digital image data that is formatted for use as input display data of a display device, for example of a micro-OLED display device. For example, the novel imaging can generate, display data that is formatted for consumption by the display without conversion. Pass through electronics disposed along a communication path between the sensor and the display can communicate the digital image data to the display device without reformatting the digital image data into a suitable format for use by the display device. In some embodiments, the pass-through electronics can add information to the digital image data without reformatting the data. For example, the sensor may include a monochrome sensor that generates monochrome digital image data, for example a Y or brightness value in a YUV color scheme. In an embodiment where the display is a color display, the pass-through electronics can add U and V values to the digital image data. In other examples, the pass-through electronics can add AR overlay information and/or calibration information to the digital image data, and can adjust the values of brightness levels.

In other aspects, the inventors have recognized that latency can be further reduced by configuring the novel imaging sensor to read out only a portion of the image data produced by the imaging sensor, generate display data based on the portion of image data, and communicate the display data to the display device, which, in turn, fills only a corresponding portion of the display with display data that is based on the portion of the image data.

The present disclosure is directed to embodiments of monocular digital night vision devices, binocular (or multi-ocular) night vision goggles, and image intensifier tubes that are included in the digital night vision devices and goggles.

In at least one aspect, the subject technology relates to a digital imaging device that includes an image intensifier tube (IIT) configured to receive a scene image corresponding to an observed scene and to produce an enhanced image based upon the scene image, a digital image sensor configured to receive the enhanced image and to generate digital image data corresponding to the enhanced image, a digital display configured to receive the digital image data and to generate a displayed image corresponding to the digital image data, pass-through electronics configured to receive the digital image data from the digital image sensor and to provide the digital image data to the digital display without performing data conversion processing on the digital image data, and an external electronics processor in communication with the pass-through electronics. The digital image sensor may be configured to output the digital image data that includes the same electrical interface as the digital display is configured to input. In some embodiments, the digital image sensor includes a complementary metal-oxide semiconductor (CMOS) sensor.

In some embodiments, the digital imaging device includes a first control clock, the functional resolution of the digital image sensor is the same as the functional resolution of the digital display, and the digital image and the digital display both operate using the first control clock.

In some embodiments, the pass-through electronics are configured to add information to the digital image data, wherein the information includes one or more of color information, brightness information, calibration information, and augmented reality (AR) overlay information.

In some embodiments, digital imaging device includes an external electronics processor in communication with the pass-through electronics and the pass-through electronics are configured to generate a copy of the digital image data and to provide the copy of the digital image data to the external electronics processor, wherein the external electronics processor is configured to determine one or more dark portions of the digital image data corresponding to one or more portions of the enhanced image having an absence of light and one or more bright portions of digital image data corresponding to one or more portions of the enhanced image data having a brightness value corresponding to light. In further embodiments, the pass-through electronics are configured to add the AR overlay information to the one or more dark portions of the digital image data and to add one or more of color and brightness information to the one or more bright portions of the digital image.

In some embodiments wherein the digital display is configured to display YUV color data, the digital image sensor generates the Y element of the YUV color data, and the pass-through electronics adds the U element and the V element of the YUV color data to the digital image data.

In some embodiments, the IIT includes a photocathode, a microchannel plate (MCP), a power supply for providing power to the photocathode and to the MCP, a fiber optic plate, and a phosphor screen. In some embodiments, the phosphor screen is deposited onto the digital image sensor.

In some embodiments, the IIT includes the digital display.

In some embodiments, the digital image is disposed on a first side of a circuit board, the digital display is disposed on a second side of the circuit board, and the digital image and digital display are aligned along a shared axis.

In some embodiments, the digital image sensor includes a CMOS sensor.

In some embodiments, the digital image sensor includes an array of digital pixels, wherein a digital pixel of the array of digital pixels is configured to perform image sensing and analog-to-digital conversion of analog image data to generate the digital image data.

In some embodiments, the digital image sensor includes a sensor array including a plurality of sensor pixels including multiple of rows of sensor pixels, the digital display includes a display array with multiple display pixels including a plurality of rows of display pixels; and the digital image sensor is configured to read out a first row of the plurality of rows of sensor pixels and to bin image data corresponding to the first row in to a first data packet and the digital display is configured to receive the first data packet and to fill a first row of display pixels with data including the first data packet, the first row of display pixels corresponding to the first row of sensor pixels.

In some further embodiments, the digital image sensor is further configured to, while reading out the first row of sensor pixels, read out a second row of the plurality of rows of sensor pixels and to bin image data corresponding to the second row in to a second data packet and the digital display is further configured to receive the second data packet and, while filling the first row of display pixels, to fill a second row of display pixels with data including the second data packet, the second row of display pixels corresponding to the second row of sensor pixels.

In at least one further aspect, the subject technology relates to a an image intensifier tube (IIT) configured to receive photons corresponding to a scene image and to produce enhanced photons corresponding to an enhanced version of the scene image, a digital image sensor configured to receive the enhanced photons and to generate digital image data corresponding to the enhanced photons a digital display configured to receive the digital image data and to generate a display image corresponding to the digital image data, wherein the digital image sensor is configured to output the digital image data formatted for consumption by the digital display without conversion.

In some embodiments, the digital image sensor includes a sensor array including a plurality of sensor pixels, the sensor array including a plurality of rows of sensor pixels, the digital display includes a display array including a plurality of display pixels, the display array including a plurality of rows of display pixels, wherein the digital image sensor is configured to read out a first row and a second row of the plurality of rows of sensor pixels and to bin image data corresponding to the first row in a first data packet and image data corresponding to the second row in a second data packet, and the digital display is configured to receive the first data packet and the second data packet and to fill a first row of display pixels with data including the first data packet, the first row of display pixels corresponding to the first row of sensor pixels and fill a second row of display pixels with data including the second data packet, the second row of display pixels corresponding to the second row of sensor pixels.

In some embodiments, the IIT tube includes the digital image sensor, the digital imaging device further including pass-through electronics disposed between the IIT tube and the digital image sensor for communicating the digital image data from the digital image sensor to the digital display.

In some further embodiments, the digital imaging device is configured to be mounted on a helmet system including a visor, the visor having an inner surface facing a wearer of the helmet system and an outer surface opposing the inner surface and the IIT tube is disposed external to the outer surface, the display is disposed between the inner surface and the wearer, and the pass-through electronics communicate the digital image data between the outer surface and the inner surface.

In some further embodiments, the IIT is disposed on a first side of a barrier, the digital display is disposed on second side of the barrier, the first side opposing the second side, and the pass-through electronics communicate the digital image data from the first side to the second side. In some embodiments, the barrier includes armor for resisting penetration by a ballistic projectile.

In the accompanying drawings, reference characters refer to the same parts throughout the different views. The drawings are not necessarily to scale; emphasis has instead been placed upon illustrating the principles of the invention. The features of the present invention will best be understood from a detailed description of the subject technology and example embodiments thereof selected for the purposes of illustration and shown in the accompanying drawings.

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Any feature or structure can be removed or omitted. Throughout the drawings, reference numbers can be reused to indicate correspondence between reference elements.

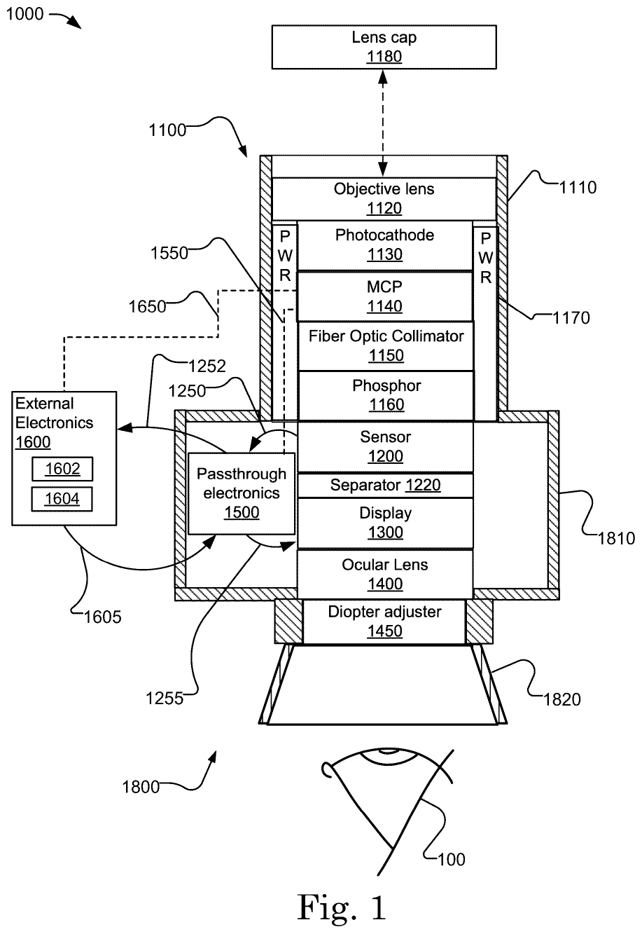

FIG. 1 is a schematic cross-sectional view of a first embodiment of a first digital night vision device (DNVD), including a first embodiment of an image intensifier tube (IIT), in accordance with the disclosed technology.

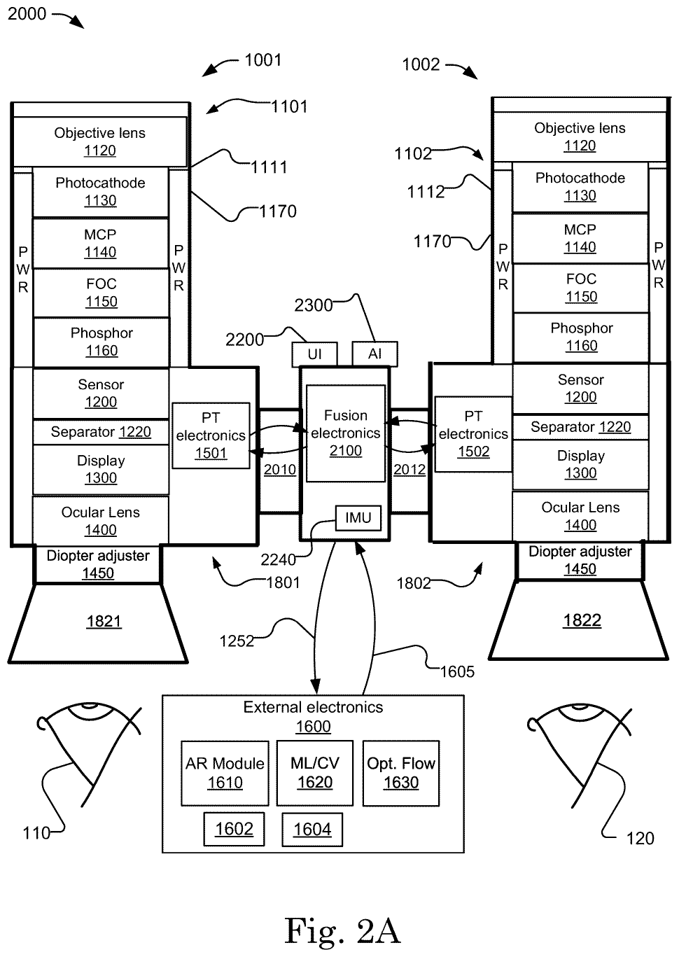

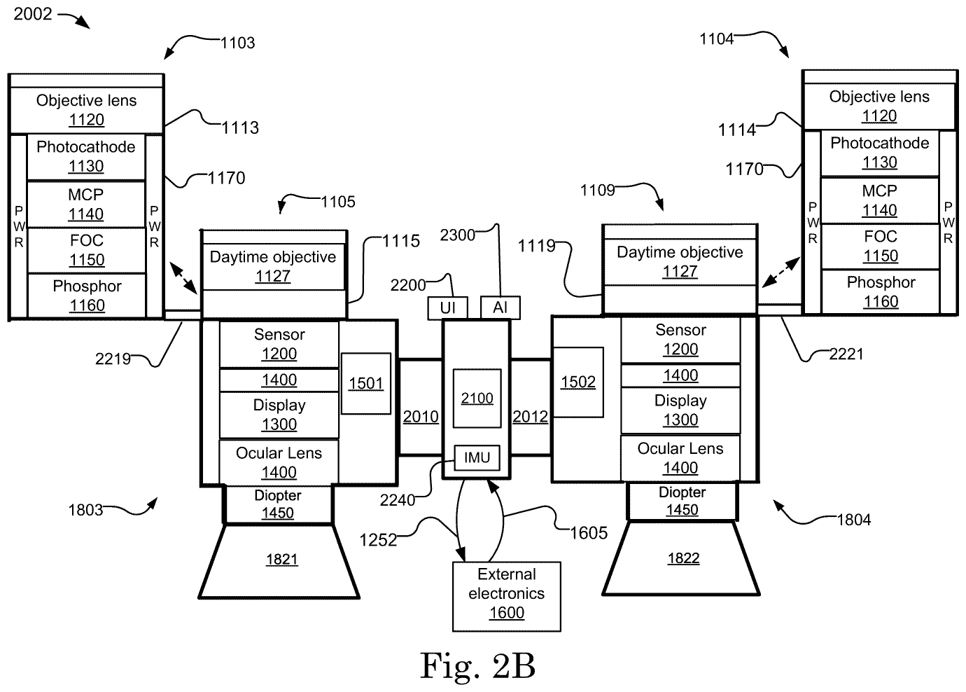

FIG. 2A is a schematic cross-sectional view of a first embodiment of a digital night vision goggle device (DNVG), including second and third embodiments of a DNVD, in accordance with the disclosed technology.

FIG. 2B is a schematic cross-sectional view of a second embodiment of a NDVG, including first and second removable embodiments of a DNVD, in accordance with the disclosed technology.

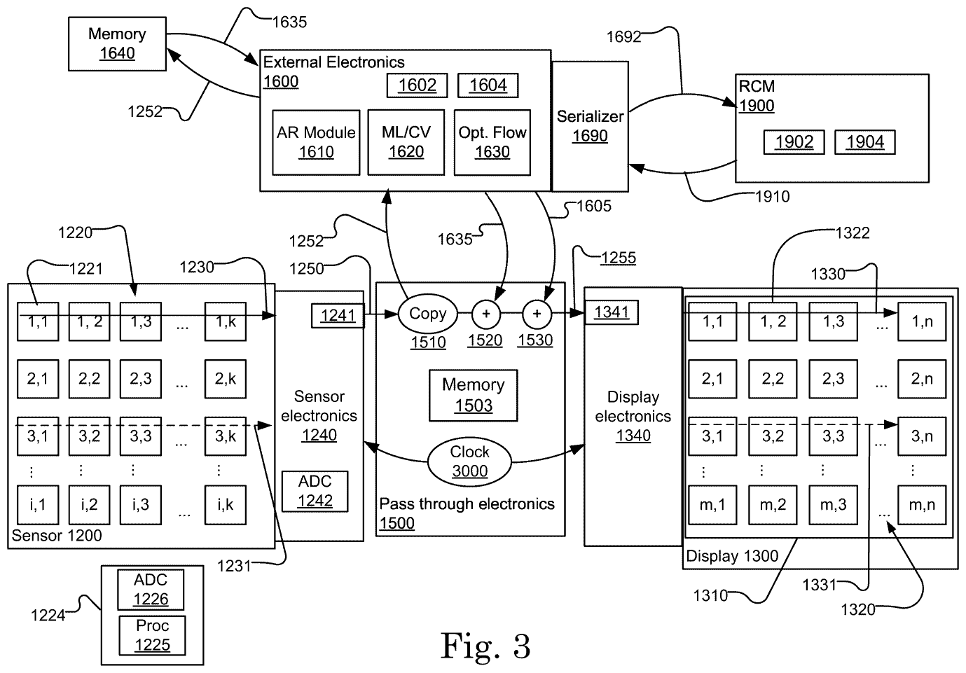

FIG. 3 is a schematic view of components of the first embodiment of the DNVD of FIG. 1, illustrating data flows.

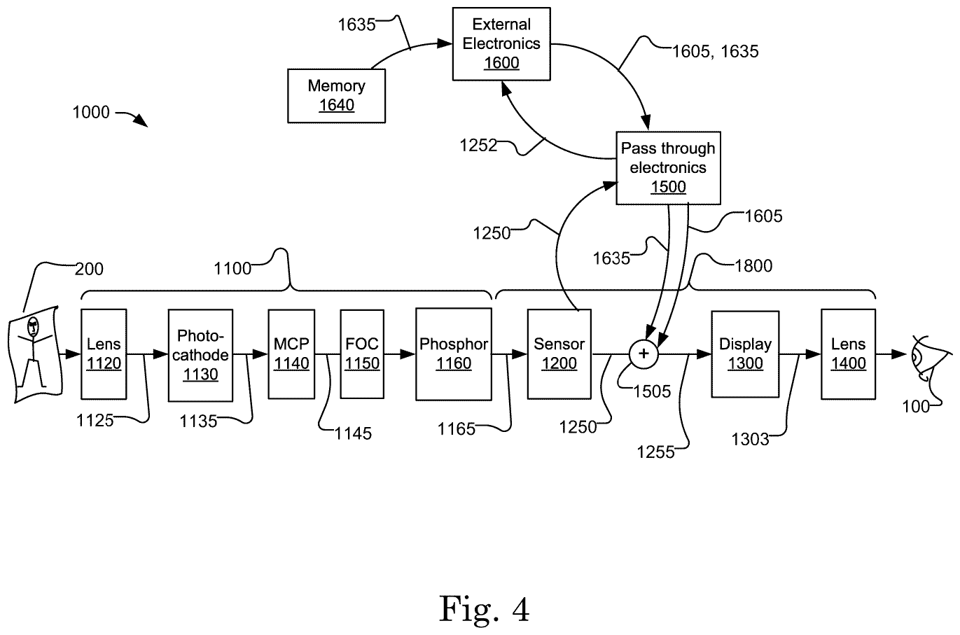

FIG. 4 is a schematic diagram of the first embodiment of a DNVD of FIG. 1, illustrating flows of photons, electrons, and data.

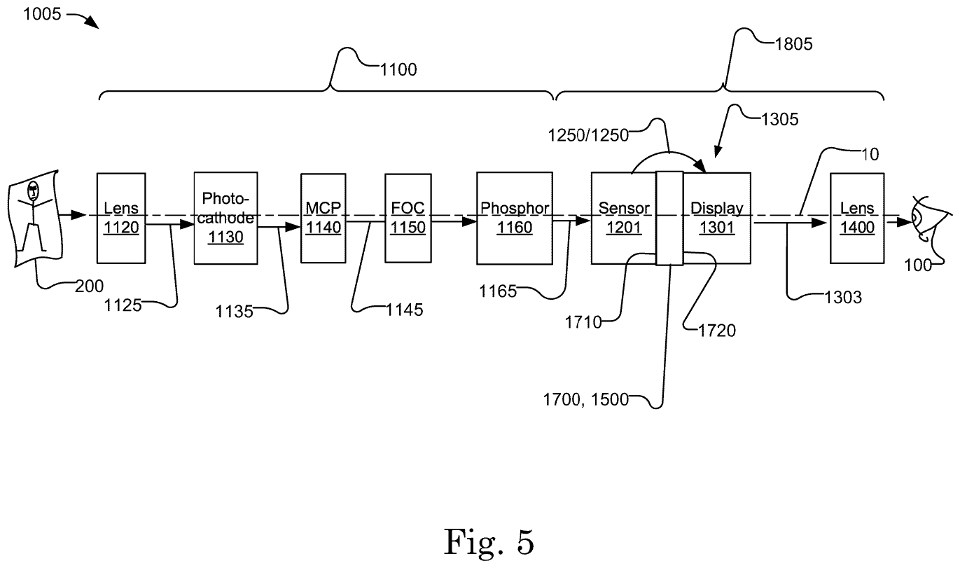

FIG. 5 is a schematic diagram of a fourth embodiment of a DNVD according to the technology disclosed herein, illustrating flows of photons, electrons, and data.

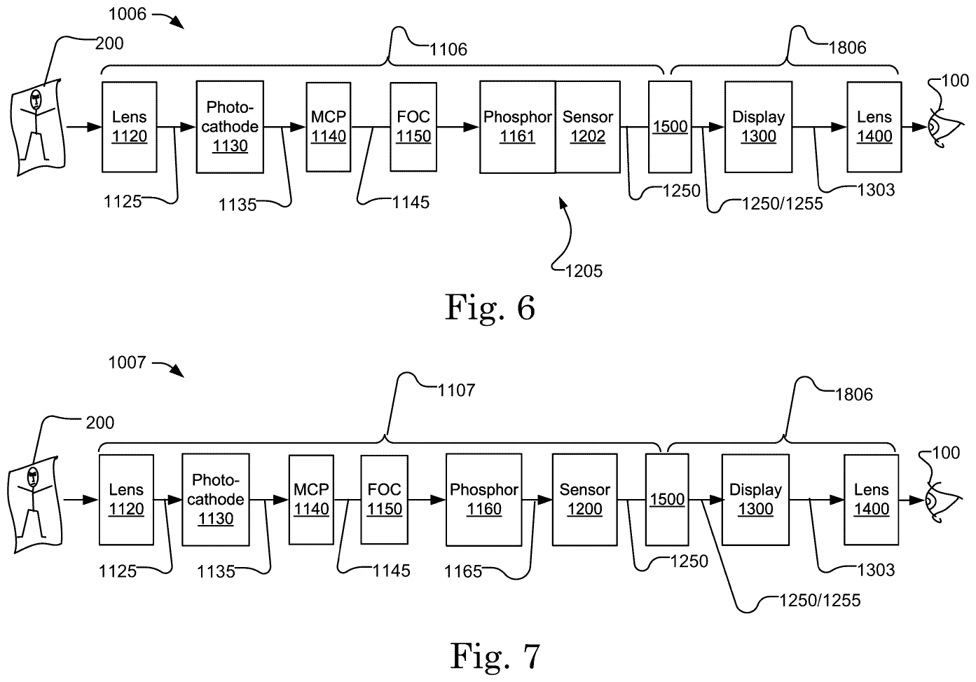

FIG. 6 is a schematic diagram of a fifth embodiment of a DNVD according to the technology disclosed herein, illustrating flows of photons, electrons, and data.

FIG. 7 is a schematic diagram of a sixth embodiment of a DNVD according to the technology disclosed herein, illustrating flows of photons, electrons, and data.

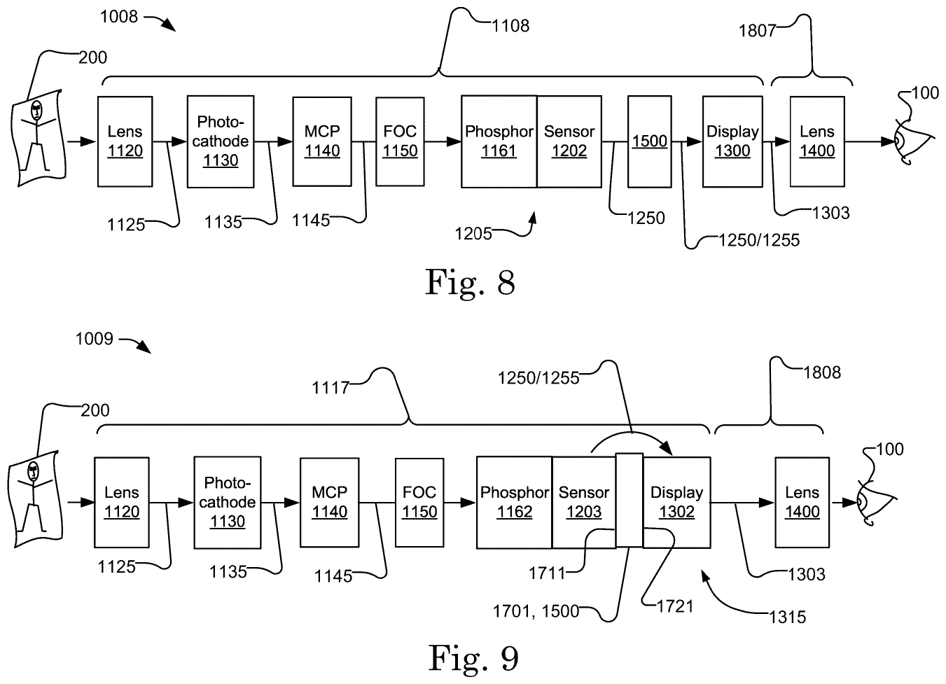

FIG. 8 is a schematic diagram of a seventh embodiment of a DNVD according to the technology disclosed herein, illustrating flows of photons, electrons, and data.

FIG. 9 is a schematic diagram of an eighth embodiment of a DNVD according to the technology disclosed herein, illustrating flows of photons, electrons, and data.

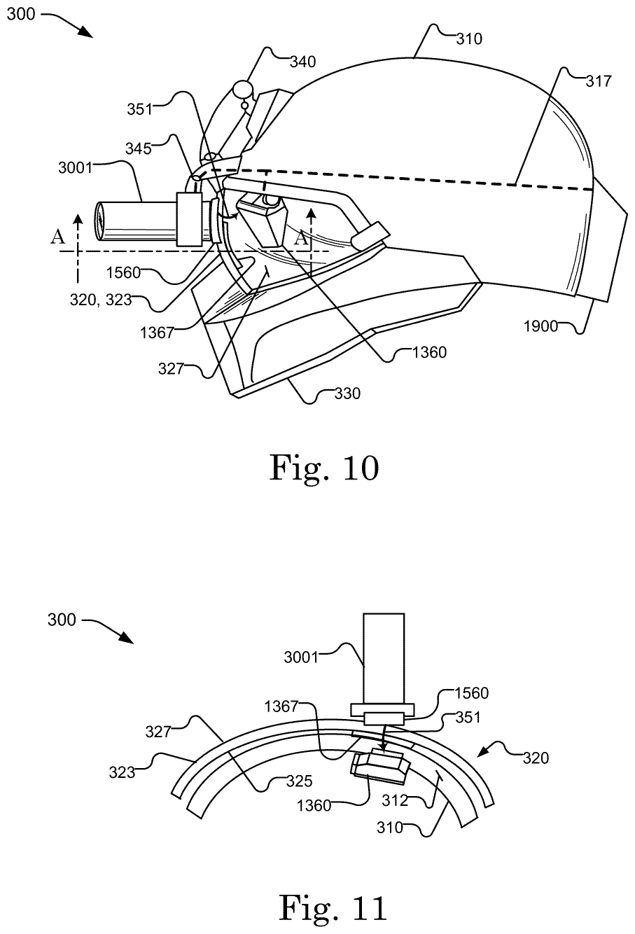

FIG. 10 is a schematic side view of a first helmet system according to the technology disclosed herein.

FIG. 11 is a schematic partial section view of the first helmet system of FIG. 10, taken through second line A.

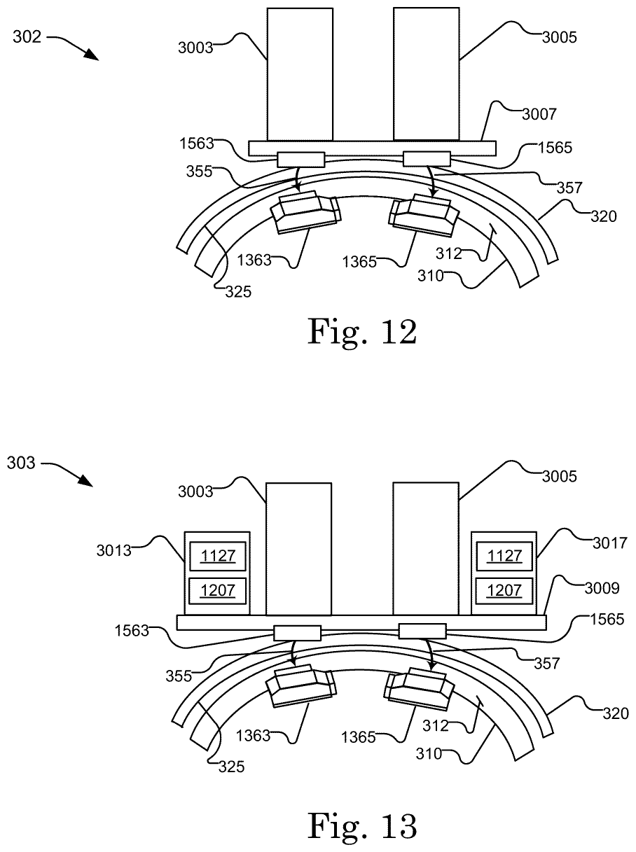

FIG. 12 is a schematic partial section view of a second helmet system, according to the technology disclosed herein.

FIG. 13 is a schematic partial section view of a third helmet system, according to the technology disclosed herein.

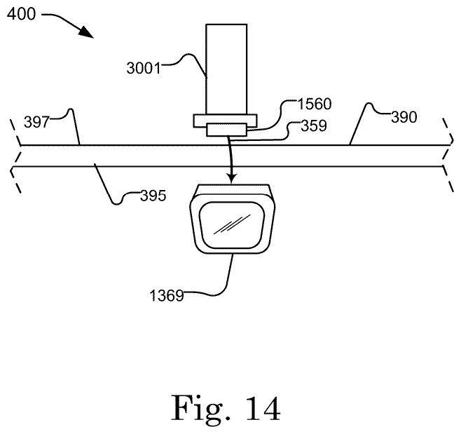

FIG. 14 is a schematic partial section view of a fourth system, according to the technology disclosed herein.

### 5 DESCRIPTION OF SOME EMBODIMENTS OF THE INVENTION

### 5.1 Detailed Description of the Invention

The subject technology now will be described more fully hereinafter with reference to the accompanying drawings, in which illustrative embodiments of the invention are shown, and wherein like reference numerals are used to refer to like elements throughout. The disclosed technology may, however, be embodied in many different forms and should not be construed as limited to the embodiments set forth herein; rather, these embodiments are provided so that this disclosure will be thorough and complete, and will enable those skilled in the art to make and use the technology disclosed herein.

In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Furthermore, the claimed subject matter may be implemented as a method, apparatus, or article of manufacture using standard programming and/or engineering techniques to produce software, firmware, hardware, or any combination thereof to control a computer to implement the disclosed subject matter.

As used herein, the term “and/or” includes any and all combinations of one or more of the associated listed items. Further, the singular forms of the articles “a,” “an,” and “the” are intended to include the plural forms as well, unless expressly stated otherwise. It will be further understood that the terms: “includes,” “comprises,” “including;” and/or “comprising,” when used in this specification, specify the presence of stated features, integers, steps, operations, elements, and/or components, but do not preclude the presence of addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Additionally, the word “exemplary” is used herein to mean “serving as an example, instance, or illustration.” Any implementation described herein as “exemplary” is not necessarily to be construed as preferred or advantageous over other implementations.

### 5.1.1 Exemplary Monocular Embodiment

Referring to FIG. 1, a first exemplary embodiment of a digital night vision device (first DNVD) 1000 is shown schematically. The first DNVD 1000 includes a first image intensifier tube (First IIT) 1100 coupled to a first camera/eyepiece (C/E) body 1800. In some embodiments, the IIT 1100 is fixedly attached to the C/E body 1800. In other embodiments, the first IIT 1100 can be removed from first the C/E body 1800, which advantageously enables a user to remove and replace the IIT 1100, for example with a same or different 1100. In exemplary, non-limiting embodiments, the first DNVD 1000 may be a part of a hand held or helmet-mounted night vision monocular device or a smart weapons scope.

The first IIT 1100 includes a first IIT enclosure 1110 which houses an objective lens 1120; a device for converting received photons to output electrons, for example photocathode 1130; a device for multiplying and accelerating electrons, for example a microchannel plate 1140; a device for aligning electrons, for example a fiber optic collimator 1150; and a device for converting received electrons to output photons, for example a phosphor device or phosphor layer, e.g. a phosphor screen 1160.

The IIT enclosure also houses a power source 1170 which provides power to the MCP 1140 and to the phosphor screen 1160. The first IIT enclosure 1110 may form a vacuum sealed enclosure. In some embodiments, one or more vacuum gaps (not shown) are disposed between at least some of the components housed in the first IIT enclosure 1110, for example between the objective lens 1120 and the photocathode 1130 and/or between the photocathode 1130 and the MCP 1140.

In operation, light enters the first IIT 1100 as photons that pass through the objective lens 1120. The objective lens may focus the light onto the photocathode 1130. The photocathode 1130, in response to photons striking it, generates electrons in a pattern that corresponds to a pattern of the photons. The photocathode 1130 is disposed such that the electrons are directed to the MCP 1140.

The electrons pass through multiple microchannels of the MCP 1140 where they are multiplied and accelerated, as is known in the art. An amount by which the electrons are multiplied and accelerated by the MCP 1140 may be termed MCP gain, or image intensifier tube (IIT) gain. The gain is correlated with how much an image is brightened by the first IIT 1100.

The accelerated and multiplied electrons exit the MCP 1140 and pass through the fiber optic collimator (FOC) 1150, or a fiber optic plate, which may narrow, e.g. align, the accelerated and multiplied electrons. The MCP 1140 and FOC 1150 are disposed such that the multiplied and accelerated electrons are directed at the phosphor screen 1160. The multiplied and accelerated electrons strike the phosphor screen 1160 which, in response, generates monochromatic photons. In this manner, the first IIT 1100 generates monochromatic photons that correspond to an enhanced, e.g. brightened, version of an image including the light that enters the first IIT 1100 through the objective lens 1120. The enhanced image may be of a portion of an environment in which the first DNVD 1000 is located.

The first IIT 1100 is coupled to a first C/E body 1800. In some embodiments, the first C/E body is configured and disposed to receive the enhanced image, as a plurality of photons, from the first IIT 1100 and to generate and display digital data that corresponds to the enhanced image. The first C/E body 1800 includes a C/E enclosure 1810 which houses a sensor 1200, a display 1300, an ocular lens 1400, and pass through electronics 1500. In some embodiments, the first C/E body 1800 also includes a separator 1220, disposed between the sensor 1200 and the display 1300, although in other embodiments, the separator 1220 may be omitted. The first C/E body 1800 includes a first face interface 1820 which is configured to interface with the face of a user such that one of the user's eyes 100 is positioned for viewing an image on a display screen of the display 1300 through the ocular lens 1400. Some embodiments of the C/E body 1800 do not include a first face interface 1820. In some embodiments the ocular lens 1400 includes a pancake optic (not shown) to magnify and direct an image on the display 1300 to the user's eye. The first C/E body 1800 includes an optional diopter adjuster 1450 which enables a user to adjust a diopter setting of the first DNVD 1000. Some embodiments of the first C/E body 1800 do not include a diopter adjuster 1450.

The MCP or IIT gain of the first IIT 1100 can be controlled by either the pass-through electronics 1500 of the first C/E body 1800 or by the external electronics 1600, which can each control a high voltage (HV) magnitude for the MCP. A pass-through electronics HV control line 1550 is connected to the pass-through electronics 1500 and the MCP 1140 or power supply 1170 to enable control of the MCP or IIT gain by the pass-through electronics 1500. An external electronics HV control line 1650 is connected to the external electronics 1600 and the MCP 1140 or power supply 1170 to enable control of the MCP or IIT gain by the external electronics 1500.

The sensor 1200 is configured and disposed to receive photons comprising the enhanced image generated by the first IIT 1100. The sensor 1200 can include any sensor capable of receiving photons, for example photons corresponding to an image, e.g. the enhanced image, and, in response, generating digital image data, or analog image data that can be converted to digital image data. The digital image data encodes a representation of the enhanced image. Exemplary embodiments of the sensor 1200 include a read out integrated circuit (ROIC) sensor, for example a digital ROIC (DROIC) or a digital pixel ROIC (DPROIC), as are known in the art. In particular embodiments, the sensor 1200 includes a complementary metal oxide semiconductor (CMOS) image sensor.

The display 1300 can include any display device capable of receiving digital image data, for example digital image data formatted as display input data, and, in response, generating a displayed image corresponding to the digital image data on a display screen of the display 1300. In an exemplary embodiment, the display 1300 includes a known micro light emitting diode (LED) display screen that includes an array of LED pixels. In another embodiment, the display 1300 includes an organic LED (OLED) display that includes an array of OLED pixels.

The separator 1220, when present, can include a printed circuit board (PCB), chip, field programmable gate array (FPGA), or the like disposed between the sensor 1200 and the display 1300.

The sensor 1200 is disposed to receive monochromatic photons generated by the phosphor screen 1160 of the IIT 1100. The sensor 1200 is configured to receive the monochromatic photons and, in response, to generate digital image data 1250 that encodes a version of an image corresponding to the received photons.

The pass-through electronics 1500 are configured to move the digital image data 1250 from an output of the sensor 1200, for example from output pins of the sensor 1200, to an input of the display 1300, for example to input pins of the display 1300. The pass-through electronics 1500 move the digital image data 1250 from the output of the sensor 1200 to the input of the display 1300 without performing data conversion processing on the digital image data 1250. The sensor 1200 is configured to generate digital image data that includes the same electrical interface as the display 1300 is configured to input. In other words, the digital image data 1250 that is generated by the sensor 1200 is configured as display data suitable for use as input to the display 1300. In embodiments, separator 1220 includes at least a portion of the pass-through electronics 1500 and, in further embodiments, all of the pass-through electronics are included in the separator 1220.

In some embodiments, the pass-through electronics 1500 are configured to add additional information to the digital image data 1250, without performing formatting processing on the digital image data 1250, thereby generating augmented digital image data 1255. In some exemplary embodiments, the pass-through electronics 1500 are configured to provide the augmented digital image data 1255 to the display 1300. In some exemplary embodiments, the pass-through electronics 1500 are configured to pass the digital image data 1250 to the display 1300 without adding additional image information to the digital image data 1250. The display 1300 receives the digital image data 1250 or the augmented digital image data 1255 from the pass-through electronics 1500 and, in response, produces an image corresponding to the image data on a display screen of the display 1300.

The pass-through electronics 1500 can add color information to the digital image data 1250. For example, in an embodiment wherein the sensor 1200 includes a monochromatic sensor, the digital image data 1250 includes a single color value, for example representing brightness, for example a brightness level of each of a plurality of pixels. As a further example, when color is represented by a YUV encoding scheme, the sensor 1200 generates digital image data 1250 that may include the Y element of the YUV color data. The pass-through electronics 1500 may add the additional U and V color data to the digital image data 1250, thereby generating augmented digital image data 1255 that includes one or more colors, which may be displayed on a display 1300 that includes a color display screen.

The first DNVD 1000 includes external electronics 1600. The external electronics 1600 includes a processor 1602 and associated memory 1604. The memory can store one or more computer-executable instructions and the processor 1602 can execute one or more of the computer executable instructions.

The pass-through electronics 1500 can receive augmentation data 1605 from the external electronics 1600. The augmentation data 1605 can include, for example, the color information that is added to the digital image data 1250 to generate the augmented digital image data 1255. The augmentation data 1605 can include one or more alternative or additional types of information to be added to the digital image data 1250. For example, the augmentation data 1605 can include calibration data, augmented reality (AR) overlay data, brightness modification data, and overnight data, one or more of which can be added, by the pass-through electronics 1500, to the digital image data 1250 to generate the augmented digital image data 1255.

In exemplary embodiments, the pass-through electronics 1500 are configured to generate a copy 1252 of the digital image data 1250 and to communicate the copy 1252 to the external electronics 1600. The external electronics 1600 can store the digital image data in memory 1604. The external electronics 1600 can operate the processor 1602 to generate information corresponding to the copy of the digital image data 1252.

In one example, the external electronics 1600, e.g. by operating the processor 1602 on the copy of the digital image data 1252, determine which of one or more digital image pixels represented by the copy of the digital image data 1252 includes a color of black, or brightness value of zero or less than a threshold value for detecting light, which may indicate that no light, or less than a threshold number of photons, from an imaged scene struck one or more sensor pixels 1212 corresponding to the one or more image pixels. The one or more pixels determined to have a color of black, or a brightness value less than the threshold value for detecting light, may correspond to one or more dark portions of the imaged scene and of the digital image data. One or more other pixels of the copy of the digital image data 1252 without a color of black, or with a brightness value greater than the threshold value for detecting light, may correspond to one or more bright portions of the imaged scene and of the digital image data.

In an exemplary operating example, the processor 1602 generates augmentation data 1605 that includes color data (e.g. U and V color data) only for pixels that are not determined to be black, e.g. only for bright portions of the imaged scene. In another exemplary operating example, the processor can determine a brightness modification factor for one or more bright portions of the image scene and can include the brightness modification factor in the augmentation data 1605. In an example, the processor 1620 determines a brightness modification factor by comparing a brightness value of one or more portions of the copy of the digital image data 1252 to a threshold value, for example to a maximum brightness value threshold. If a first portion of the copy of the digital image data 1252 has a brightness value that is greater than the maximum brightness value threshold, the processor may determine a brightness modification factor that, when added to the digital image data 1250, reduces the brightness of a first portion of the augmented digital image data 1252 corresponding to the first portion of the copy of the digital image data 1252.

In some embodiments, the processor 1602 generates augmentation data 1605 that include augmented reality (AR) data. In some particular embodiments, the processor 1602 only generates AR data for overlay on one or dark portions of the imaged scene.

One or more of the pass-through electronics 1500 and the external electronics 1600 are operable to control a gain of the IIT 1100, for example by controlling a voltage or current setting of the power source 1170.

The first DNVD 1000 may include a removable lens cap 1180 that is configured to cover and protect the objective lens 1120 when the lens cap 1180 is assembled onto the first DNVD 1000.

### 5.1.2 First Exemplary Binocular Embodiment

Referring now to FIG. 2A, a schematic view a first exemplary embodiment of a first digital night vision goggle device (first DNVG) 2000 is shown. The first DNVG 2000 includes two instances of DNVDs, second DNVD 1001 and third DNVD 1002. The second and third DNVDs 1001 and 1002 are each substantially similar to the first DNVD 1000 shown in FIG. 1. The second DVND 1001 includes a second IIT 1101 and a second C/E body 1801. The third DVND 1002 includes a third IIT 1102 and a third C/E body 1802. The second and third IITs 1101 and 1102 are each substantially similar to the first IIT 1100 and the second and third C/E bodies 1801 and 1802 are each substantially similar to the first C/E body 1800. The second IIT 1101 includes a second IIT enclosure 1111, and the third IIT 1102 includes a third IIT enclosure 1112. The first DNVG 2000 includes external electronics 1600. The second DNVD 1001 includes second pass-through electronics 1501 and third DNVD 1002 includes third pass-through electronics 1502. The second and third pass-through electronics 1501 and 1502 are each communicatively coupled with the external electronics 1600, which may be included within a housing of the DNVG 2000.

The second and third DNVDs 1001 and 1002 are arranged in a binocular configuration such that when the first DNVG 2000 is operated by a user, a first face interface 1821 is disposed proximal to a first eye 110 of the user and a second face interface 1822 is disposed proximal to a second eye 120 of the user. The second and third DNVDs 1001 and 1002 are joined together by a structure that includes bridge arms 2010 and 2012 and that houses fusion electronics 2100. The first and second pass-through electronics 1501 and 1502 communicate with the external electronics 1600 via the fusion electronics 2100, as indicated by curved arrows.

The external electronics 1600 includes an augmented reality (AR) module 1610, a machine learning/computer vision (ML/CV) module 1620, and an optical flow module 1630, each of which represents computer instructions that may be stored on the memory 1604 and executed by the processor 1602. The AR module 1610 can be executed to generate augmentation data 1605 that include one or more AR icons or other AR overlays to be displayed on the display 1300. The ML/CV module 1620 is configured to operate one or more trained ML and/or CV models on digital image data 1252 received by the external electronics 1600 from the PT electronics 1501 and 1502. Exemplary models operable by the ML/CV module 1620 include models trained to detect events or specific objects based on the digital image data 1252. The optical flow module 1630 is configured to operate on the digital image data 1252 to generate data including one or more of a position, posture, or relative motion of the first DNVG 2000.

Embodiments of the first DNVG 2000 include a user interface (UI) 2200 for controlling one or more functions of the DNVG and for adjusting a configuration of the DNVG, for example for adjusting relative positions of the second DNVD 1001 and the third DNVD 1002. The UI 2200 can include one or more operable control elements, for example a knob, one or more buttons, etc.

Embodiments of the first DNVG 2000 include one or more additional interfaces (AIs) 2300. The one or more AIs 2300 each provide an interface for communication between the first DNVG 2000 and an additional system (not shown), for example to receive data from an infrared (IR) imaging system or another type of imaging system. The fusion electronics 2100 or the external electronics 1600 can generate augmentation data 1605 that includes image data from an additional system, thereby enabling display of the image data from the additional system overlaid with digital image data based on outputs of the second and third DNVDs 1001 and 1002.

In some embodiments, the first DNVG 2000 includes an inertial measurement unit (IMU) 2240 for generating inertial data, for example data related to one or more of acceleration, orientation, specific force, and angular rate of the first DNVG 2000 which may be used by the external electronics 1600 for generating position, posture, and relative motion data in addition to or alternatively to such data generated by the optical flow module 1630. Referring now to FIGS. 1 and 2A, it is noted that, although not shown in FIG. 1, some embodiments of the first DNVD 1000 include one or more of: a user interface 2200; one or more additional interfaces 2300; and an IMU 2240. It is further noted that external electronics 1600 of the first DNVD 1000 may include one or more of AR module 1610, ML/CV module 1620, and optical flow module 1630.

The second and third DNVDs 1101 and 1102 of the DNVG 2000 each includes an optional diopter adjuster 1450 which enables a user to independently adjust a diopter setting of each of the second DNVD 1001, and third DNVD 1002. In some embodiments, one or both of the second and third DNVDs 1101 and 1102 do not include a diopter.

### 5.1.3 Second Exemplary Binocular Embodiment

Referring to FIG. 2B, a schematic view of a second exemplary embodiment of a second DNVG 2002 device is shown. The second DNVG 2002 includes first and second removable IITs 1103 and 1104, which include first and second removable IIT enclosures 1113 and 1114 respectively. First and second removable IITs 1103 and 1104 can be replaced with corresponding first daytime optics 1105 and second daytime optics 1109. The first daytime optics 1105 and second daytime optics 1109 each include a daytime objective 1127 housed in an enclosure, i.e. within a first daytime optics enclosure 1115, and a second daytime optics enclosure 1119, respectively. The first and second daytime optics 1105 and 1109 can be used to provide, to the sensors 1200, photons representing an environmental scene during daylight or other bright light operation. The first and second removable IITs 1103 and 1104 can be used during nighttime or other low light operation, as described herein.

In a first exemplary embodiment of the second DNVG 2002, first and second removable IITs 1103, 1104 and first and second daytime optics 1105, 1109 are each removable from and replaceable on third and fourth C/E bodies 1803, 1804. In a second exemplary embodiment, the first and second removable IITs 1103, 1104 and first and second daytime optics 1105, 1109 remain attached to the third and fourth C/E bodies 1803, 1804, for example by first and second attachment fixtures 2219, 2221 but are movable relative thereto, such that they can be selectively positioned in line with the sensors 1200 of the C/E bodies 1803, 1804. In an exemplary embodiment, the first attachment fixture 2219 and second attachment fixture 2221 each provide a rotatable platform such that a first or second removable IIT (1103 or 1104) is rotatable relative to a corresponding first or second daytime optic (1105 or 1109, respectively), and a user can selectively reposition an IIT and a daytime optic by rotating them into or out of position in line with sensors 1200.

It is noted that, although not shown for clarity, each the first and second DNVGs 2000 and 2002 includes HV control lines 1550 connected between pass through electronics 1501, 1502 and corresponding MCPs 1140 as well as external electronics control lines 1650 connected between the external electronics 1600 and the MCPs 1140 such that the MCP, for example a power level or gain of the MCPs 1140, can be controlled either by pass through electronics 1501 and 1502 or by the external electronics 1600. It is further noted that additional embodiments of a digital night vision device, e.g. of first or second DNVG 2000 or 2002 can include more than two IITs, for example 3 or more IITs, wherein each IIT is associated with a separate C/E body, or with a separate instance of electronic components including a C/E body.

### 5.1.4 Exemplary Sensor Readout and Display Fill

Referring to FIG. 3, an exemplary schematic diagram of components included in embodiments of DNVDs according to the subject technology are shown. FIG. 3 includes a depiction of exemplary sensor readout and display fill. The exemplary sensor readout and display fill can be carried out by any embodiment of a DNVD according to the subject technology disclosed herein, for example by first DNVD 1000 (see FIGS.1 and 4), second DNVD 1001 and third DNVD 1002 (see FIGS. 2A and 2B), and fourth through seventh DNVDs 1005 through 1008 (See FIGS. 6 through 8).

The DVND components include a sensor 1200 that includes sensor electronics 1240, pass through electronics 1500, a display 1300 that includes display electronics 1340, an external memory 1640, and external electronics 1600 including processor 1602 and memory 1604 in communication with the pass-through electronics 1500 and with the external memory 1640. The external electronics 1600 includes a serializer 1690 which enables communication of data to and from a remote compute module (RCM) 1900. The pass-through electronics 1500 includes a control clock 3000 which is operable to provide a clock signal to both the sensor electronics 1240 and the display electronics 1340.

The display 1300, for example a micro-OLED display, includes a display screen 1310 that includes a display pixel array 1320 made up of multiple individual display pixels 1322. Each display pixel 1322 includes at least one light emitting element, for example at least one LED or at least one OLED. The display pixels 1322 are arranged in multiple rows (1 through m) and multiple columns (1 through n) where m and n are each whole numbers. A display 1300 may be described as having a resolution of m×n pixels, for example including, but not limited to, 640×480 pixels, 800×600 pixels, 1280×1024 pixels, 1600×1200 pixels, or 1920×1200 pixels.

The sensor 1200, for example a CMOS image sensor or a CCD sensor, includes a sensor pixel array 1221 made up of multiple individual sensor pixels 1222. The sensor pixels 1222 are arranged in multiple rows (1 through i) and multiple columns (1 through k) where i and k are each whole numbers. A sensor array may be described as having a resolution of i×k pixels, for example including, but not limited to, 640×480 pixels, 800×600 pixels, 1280×1024 pixels, 1600×1200 pixels, or 1920×1200 pixels. In embodiments, the functional resolution of the sensor 1200 is the same as the functional resolution of the display 1300, which enables the sensor electronics 1240 and the display electronics 1340 to operate using the same, single, control clock 3000. In an exemplary embodiment, i=m and k=n.

The display 1300 includes display electronics 1340. The display electronics include one or more input pins 1341 that are configured to receive digital image data 1250 or augmented digital image data 1255 that is formatted as input for the electrical interface of the display 1300. The display electronics 1340 are configured to operate on the digital image data and to control operation of one or more display pixels 1322 based on the digital image data; for example, by activating and controlling a brightness and color output of the one or more of the display pixels 1322. The activation and control of the one or more display pixels 1322 by the display electronics 1340 is referred to herein as image fill. In an embodiment, the display electronics 1340 activates and controls sequential display pixels 1322 of a particular row of display pixels, for example row 1, as indicated by arrow 1330.

The sensor 1200 includes sensor electronics 1240. The sensor electronics 1240 are configured to control operation of the sensor 1200, for example by controlling one or more switches (not shown) to readout and reset the sensor pixels 1221, as is known in the art. The sensor electronics 1240 include one or more analog to digital converters (ADCs) 1242 in embodiments that include analog sensor pixels.

In some embodiments, the sensor 1200 includes digital pixels 1224. Each digital pixel 1224 includes an ADC 1226 and a processor 1225. The digital pixels 1224 perform sensing to generate analog image data in response to photons and analog to digital processing of the analog image data to generate digital image data at the pixel level. In embodiments that include digital pixels 1224, the sensor electronics 1240 may not include an ADC 1242. The digital pixels 1224 can perform other processing functions on the image data including, for example, calibration to generate calibrated digital image data and filtering to generate filtered digital image data.

The sensor electronics 1240 are configured to generate digital image data 1250 that is formatted for the electrical interface of the display 1300 and to present the digital image data 1250 at a sensor output interface 1241. The digital image data 1250 generated by the second electronics 1240 is formatted for consumption by the display 1320 without conversion. In an exemplary embodiment, the digital image data 1250 includes 10-bit monochrome image data. The pass-through electronics 1500 receive the digital image data 1250 from the sensor electronics 1240. A copy function 1510 of the pass-through electronics 1500 generates a 1252 copy of the digital image data 1250 and the pass-through electronics provides the copy 1252 to the external electronics.

In some embodiments, the pass-through electronics 1500 includes a first add function 1520 that receives calibration data 1635 from the external electronics 1600, or from a memory 1503 including the pass-through electronics. The first add function 1520 combines the calibration data 1635 with the digital image data 1250. A second add function 1530 of the pass-through electronics 1500 receives augmentation data 1605 from the external electronics 1600, as previously described, and combines the augmentation data 1605 with the digital image data 1250. In this manner, the pass-through electronics generates augmented digital image data 1255 that includes one or more of the calibration data 1635 and the augmentation data 1605. In some embodiments, the augmented digital image data includes 16-bit data.

It is notable that the augmented image data remains formatted for consumption, without coversion, by the electrical interface of the display 1300 with the addition information (e.g., augmentation data 1605 or calibration data 1635) to generate augmented digital image data 1255. Advantageously, the pass-through electronics 1500 receive, from the sensor 1200, digital image data 1250 that is configured to be used as input data by the display 1300 such that the pass-through electronics 1500 need only perform non-conversion, i.e. non-reformatting, operations on the digital image data 1250. This is different from conventional systems which require at least one processor disposed in a communication pathway between a sensor and a display to perform one or more reformatting operations on the digital image data, thereby introducing an amount of latency which systems according to the disclosed technology do not introduce.

In some exemplary embodiments, a sensor 1200 may be designed and constructed to include a functional resolution that is the same as the functional resolution of a known display 1300 and can be configured to generate digital image data 1250 that is formatted specifically for use as input display data for the known display 1300. This is advantageous in that a custom sensor 1200 can be created that generates digital image data 1250 that is suitable for display input of an existing display 1300, for example for a consumer off the shelf (COTS) OLED display. In this manner, a novel DNVD, e.g. 1000, and novel DNVG, e.g. 2000, can be constructed using a number of non-custom components, which may reduce manufacturing costs.

As illustrated in FIG. 3, the sensor 1200 may perform readout of a single row of sensor pixels 1221 at a time, as indicated by arrow 1230, while the display 1300 performs image fill on a corresponding row of display pixels 1322, as indicated by arrow 1330. In an exemplary embodiment, the sensor electronics bin readout data from a single row of pixels, e.g., places the readout data from a single row of pixels into a single data packet, and communicate the binned single-row data to the display 1300. In an exemplary embodiment, the data includes digital image data generated by digital pixels 1224. In other embodiments, the sensor 1200 may read out two or more rows of pixels at the same time, while the display 1300 performs image fill of two or more corresponding rows of display pixels 1321. In this embodiment, the sensor bins data from each of the two or more rows of pixels separately, e.g. in two separate data packets, and communicates the binned data to the display 1300.

As used herein in relation to some exemplary embodiments, the terms “bin” or “binning” may refer to collecting image data corresponding to multiple image sensor pixels 1221, for example image data produced by multiple digital pixels 1224, in a single read out operation and combining the image data, or digital image output data 1250 generated based on the collected image data, from the multiple image sensor pixels together, for example in a single data packet, wherein the combined data can be extracted to re-create data for use in filling display pixels that correspond to the image sensor pixels. In embodiments, the binned data may not be combined together with an arithmetic function, for example an averaging function, that does not allow the extraction of information corresponding to individual image sensor pixels.

In an exemplary operating mode, the sensor may perform readout of a first row of pixels, indicated by arrow 1230 while simultaneously performing readout of a third row of pixels, indicated by arrow 1231. The display 1300 performs image fill on corresponding first and third rows of pixels, as indicated by arrows 1330 and 1331. In further embodiments, the sensor 1200 may perform readout on more than two rows of sensor pixels 1221 while the display 1300 performs image fill on corresponding rows of display pixels 1322. In a particular exemplary embodiment, the sensor 1200 performs image readout on every odd numbered row of sensor pixels 1221 and the display performs image fill on corresponding odd numbered rows of display pixels 1322 following which the sensor reads out even numbered rows of sensor pixels 1221 while the display fills even rows of display pixels 1322. This novel operating mode provide advantages as compared to known image sensors, which readout a full array of sensor pixels at once, e.g. read out all sensor pixels 1221 of sensor pixel array 1220, and bin readout data form the whole row, e.g., in a single data packet. Readout of the whole sensor array takes time and may generate lag, which is substantially reduced by methods of reading out and binning data from individual rows of sensor pixel 1221 according to embodiments of the technology disclosed herein.

In an embodiment, the display electronics receives one or more packets of binned data, each associated with a particular row of sensor pixels 1221, unpacks the binned data from the one or more packets, determines a row of display pixels that corresponds to each packet, i.e. that corresponds to the row of sensor pixels associated with the data packet, and fills a corresponding row of display pixels 1322 with the unpacked data.

In this embodiment, the sensor 1220 and display 1320 are configured to readout and fill rows of pixels in parallel. A number of rows processed in parallel corresponds, in some embodiments, to a number of chip sets provided in the sensor electronics 1240 and the display electronics 1340, for example when a single chipset processes data from a single row of pixels.

The RCM 1900 includes at least one processor 1902 and at least one memory store 1904. The RCM 1900 is a compute module that is separate from a DNVD, for example, referring now to FIG. 1, from first DNVD 1000 and from a DNVG, for example, and referring now to FIG. 2A, from the first DNVG 2000. Referring once again to FIG. 3, the RCM 1900 may be mounted on a user's torso (not shown), on a helmet (not shown) worn by a user, or on a piece of equipment (not shown) carried by a user. The RCM 1900 may be coupled to the external electronics 1600 over a wired or wireless connection, for example over a wired or wireless soldier personal area network (PAN) connection.

The RCM 1900 can receive serialized 10-bit monochromatic digital image data 1692 from the external electronics 1600. In some embodiments, the RCM 1900 communicates, to the external electronics 1600, RCM data 1910 that the external electronics 1600 may communicate to the pass-through electronics 1600 as augmentation data 1605. The RCM data 1910 may include one or more types of image data, AR overlay data, or other data that are usable by the external electronics 1600 to generate the augmentation data 1605, for example location, heading, temperature, or other environmental data.

### 5.1.4.1 Exemplary Image Enhancement Tube Embodiments

Referring now to FIGS. 1, 2A, and 2B, and FIGS. 4 through 9; FIG. 4 shows a functional diagram of components of the first DNVD 1000, previously described in relation to, for example, FIG. 1, and including first image intensifier tube 1100. FIGS. 5 through 9 show additional exemplary embodiments of fourth through eighth DNVDs 1005, 1006, 1007, 1008, and 1009. The fifth through eighth DNVDs 1006, 1007, 1008, and 1009 include additional exemplary embodiments of fourth through sixth image intensifier tubes 1106, 1107, 1108, and 1117 respectively. It is noted that the first DNVG 2000 (see FIG. 2A) and second DNVG 2002 (see FIG. 2B) can include any of the exemplary DNVDs, e.g., 1000, 1005, 1006, 1007, 1008, or 1009. It is further noted that each of the exemplary DNVDs, e.g., 1000, 1005, 1006, 1007, 1008, and 1009 shown in FIGS. 4 through 9 can include components of first DNVD 1000 that are shown in FIG. 1, some of which are omitted in at least some of FIGS. 4 through 9 for clarity; for example each DNVD typically includes external electronics 1600, pass through electronics HV control line 1550, external electronics HV control line 1650, and power supply 1170 and may optionally include a diopter adjuster 1450 and a face interface 1820. In operation, the face interface 1820 of each DNVD is disposed near an eye 100 of a user while the lens 1120 is disposed to receive light representing a low light scene 200.

Referring now to FIG. 4, photons 1125 corresponding to a low light scene 200 pass through the objective lens 1120 and impinge on the photocathode 1130. The photons 1125 may be focused by the objective lens 1120 to direct them to the photocathode 1130. The photons 1125 may include, for example, photons from moonlight, starlight, or another relatively dim (e.g. relative to bright daylight) source of light that reflect off the surfaces of objects that make up the low light scene. The photocathode 1130 generates, in response to the photons 1125, electrons 1135, which may be termed photo-electrons. The electrons 1135 are generated in a pattern that corresponds to a pattern of the photons 1125 which, in turn, corresponds to the low light scene.

The electrons 1135 pass through the microchannel plate (MCP) 1140, which generates accelerated and multiplied electrons 1145 through interaction of the electrons 1135 with inner surfaces of multiple micro channels that make up the MCP 1140, as is known in the art. Referring once again to FIG. 1, the power source 1170 provides, to the MCP 1140, electrical energy that is used to accelerate and multiply the electrons 1135, thereby generating the accelerated and multiplied electrons 1145. The accelerated and multiplied electrons 1145 pass through the fiber optic collimator (FOC) 1150, or a fiber optic plate, which may narrow, e.g. align, the accelerated and multiplied electrons. The accelerated and multiplied electrons 1145 exit the FOC 1150 and impinge on the phosphor screen 1160. In response to the accelerated and multiplied electrons 1145, the phosphor screen 1160 generates monochromatic photons 1165 in a pattern that corresponds to an enhanced version of the low light scene.

The monochromatic photons 1165 leave the first image intensifier tube 1100 and enter the first C/E body 1800 wherein they strike the sensor 1200. The sensor 1200 generates digital image data 1250 corresponding to the monochromatic photons 1165, as previously discussed. The pass-through electronics 1500 can make a copy 1252 of the digital image data 1250 and provide the copy 1252 to the external electronics 1600.

The external electronics 1600 may provide one or more of calibration data 1635 and augmentation data 1605 to the pass-through electronics 1500, which in turn adds, at add function 1505, one or more of the calibration data 1635 and the augmentation data 1605 to the digital image data 1250, thereby generating augmented digital image data 1255. The pass-through electronics provides the augmented digital image data 1255 to the display 1300. In some embodiments, the pass-through electronics 1500 does not add calibration data 1625 or augmentation data 1605 and instead provides the digital image data 1250 directly to the display.

The display 1300 generates, based on the digital image data 1250 or augmented digital image data 1255, an image 1320 which includes an enhanced, e.g. brightened and otherwise augmented, version of the low light image. The image 1303 can be viewed through the ocular lens 1400 by the eye of a user 100. In some embodiments the ocular lens 1400 is or includes a pancake optic that enlarges and focuses the image 1303 for optimal viewing by the user.

Referring to FIGS. 4 through 9, it is noted that although the pass-through electronics 1500, add function 1505, external electronics 1600, and external memory 1640 are not shown in FIGS. 5 through 9 for clarity, it is understood that each embodiment of a DNVD 1005, 1006, 1007, 1008, and 1009 can include some or all of these components.

Referring now to FIG. 5, a fourth exemplary embodiment of a DNVD (fourth DNVD) 1005 includes an integrated sensor and display 1305 disposed in sixth embodiment of a C/E body (sixth C/E body) 1805. The integrated sensor and display 1305 includes a first circuit card 1700, for example a printed circuit board (PCB). In embodiments, the first circuit card 1700 includes a programable chip, for example field programmable gate array (FPGA), or other configurable circuit. A sensor 1201 is mounted on a first side 1710 of the first circuit card 1700. A display 1301 is mounted on a second side 1720 of the first circuit card 1700, wherein the second side 1720 opposes the first side 1710. In exemplary embodiments, the sensor 1201 and display 1301 are aligned along a shared axis 10 along which elements of the image intensifier tube 1100 are also aligned. In other words, the sensor 1201 and display 1301 are bore sighted with the image intensifier tube 1100. In some embodiments, the circuit card includes at least a portion of the pass-through electronics 1500 (see FIG. 4) and the digital image data 1250 or augmented digital image data 1255 is passed through the first circuit card 1700 from the sensor 1201 to the display 1301.

Referring to FIGS. 1 through 2B and 4 through 8, it is noted that although a shared axis 10 is shown only in FIG. 5, other embodiments of DNVDs according to the subject technology may include components of IITs and C/E bodies aligned along a shared axis, similar to the fourth DNVD 1005.

Referring to FIG. 6, a fifth exemplary embodiment of a DNVD (fifth DNVD) 1006 includes a fourth embodiment of an image intensifier tube (fourth IIT) 1106 with an integrated sensor and phosphor 1205. The integrated sensor and phosphor 1205 includes a sensor 1202 with a layer of first phosphor material 1161 deposited on the sensor 1202. The sensor 1202 is substantially similar to sensor 1200, (see, for example FIGS. 1 and 4). An exemplary embodiment of the sensor 1202 includes a CMOS image sensor.

The layer of first phosphor material 1161 includes one or more phosphor materials, for example grains including a phosphor material that emits light when contacted by electrons, disposed on the sensor array of the sensor 1202. When accelerated and multiplied electrons 1145 impinge on the first phosphor layer 1161, the phosphor material generates photons in response. The photons are sensed by the sensor 1202, which, in response, generates digital image data 1250 corresponding to the photons.

The first phosphor material 1161 may be disposed on the sensor 1202 using any suitable method as is known in the art; for example, but not limited to, sedimentation or epoxy coating. This advantageously eliminates the need for a separate phosphor screen element. For example (and referring to FIGS. 4 and 5), the phosphor screen 1160 can be eliminated from the image intensifier tube which may reduce cost and complexity of manufacturing. Referring once again to FIG. 6, the integrated sensor and phosphor 1205 may be included in the fourth IIT 1106, i.e. a process for manufacturing the fourth IIT 1106 incorporates the integrated sensor and phosphor 1205 into the fourth IIT 1106.

A corresponding seventh C/E body 1806 does not include a separate sensor. Digital image data 1250 or augmented digital image data 1255 is passed from the sensor 1202 within the fourth IIT 1106 to the display 1300 within the C/E body 1806. In some embodiments of DNVD 1006, pass-through electronics 1500 are disposed at the interface of the fourth IIT 1106 and the seventh C/E body 1806 or may include one of the image intensifier tube 1102 and the seventh C/E body 1806.

Referring to FIG. 7, a sixth DNVD 1007 includes a fifth IIT 1107 and an instance of the seventh C/E body 1806, described previously in relation to FIG. 6. The fifth IIT 1107 is substantially similar to the fourth IIT 1106 except that it includes a separate instance of a phosphor screen 1160 and a sensor 1200 instead of the integrated sensor and phosphor 1205 of the fourth IIT 1106. The fifth IIT 1107 provides digital image data 1250 to the pass-through electronics 1500 which is communicated therethrough to the display 1300 of the seventh C/E body 1806, as described in relation to FIG. 7.

Referring to FIG. 8, a seventh exemplary embodiment of a DNVD (seventh DNVD 1008) includes sixth embodiment of an image intensifier tube (sixth IIT) 1108 that includes the integrated sensor and phosphor 1205 as described in relation to FIG. 6, as well as the display 1300. A process for manufacturing the sixth IIT 1108 incorporates the integrated sensor and phosphor 1205 and the display 1300, with corresponding pass-through electronics 1500, as components of sixth IIT 1108. This may be advantageous as compared to the fifth and sixth DNVDs 1006 and 1007 (See FIGS. 6 and 7) because no digital signal data need be passed from the sixth IIT 1108 to the eighth C/E body 1807 to generate an image 1303. This enables a simplified eighth C/E body 1807 and a simple mechanical interface between the eighth C/E body 1807 and the sixth image intensifier tube 1108. In some embodiments, the eighth C/E body 1807 may include one or more of external electronics 1600 and a source of power for the sixth IIT 1108, in which case the sixth IIT 1108 may be electrically coupled with the eighth C/E body 1807 for communication of data and power signals therebetween.

Referring to FIG. 9, an eighth exemplary embodiment of a DNVD (eighth DNVD) 1009 includes a seventh embodiment of an image intensifier tube (seventh IIT) 1117 with an integrated phosphor-sensor-display 1315. The integrated phosphor-sensor-display 1315 includes a sensor 1203 disposed on a first side 1711 of second circuit card 1701 and a display 1302 disposed on a second side 1721 of the circuit card. In embodiments, the second circuit card 1701 includes a programable chip, for example field programmable gate array (FPGA), or other configurable circuit.

Referring now to FIGS. 5 and 9, the sensor 1203, second circuit card 1701, and display 1301 are substantially similar to sensor 1201, first circuit card 1700, and display 1301 of the sixth C/E body 1805; and together operate in a manner similar to that of integrated display and sensor 1305, as described in relation to FIG. 5.

Referring now to FIGS. 6, 8, and 9, the phosphor layer 1162 is similar to first phosphor layer 1161 and is disposed on the sensor 1162 in a similar manner. Accelerated and multiplied electrons 1145 strike the phosphor layer 1162, which emits photons in response. The photons are sensed by the sensor 1203 which generates digital image data 1250 corresponding to the photons. The digital image data 1250, or augmented digital image data 1255, is communicated to the display 1302 via the pass-through electronics 1500.

Referring once again to FIGS. 6 and 7, the fifth DNVD 1006 and sixth DNVD 1007 each provide separate optical paths that do not necessarily need to be coupled to each other. The fourth IIT 1106 does and fifth IIT 1107 are each operable to produce digital image data 1250 and augmented digital image data 1255, which may be communicated to a display 1300 over one of more electrically conductive pathways that are included in the pass-through electronics 1500, which enables the display to receive digital image data or augmented digital image data from an IIT (1106 or 1107) that is not aligned along the same optical pathway as the seventh C/E body 1806. The seventh C/E does not need to be bore sighted with the fourth or fifth IIT 1106 or 1107. This enables embodiments where an IIT (1106 or 1107) is offset from an image-producing device, for example from the display 1300, and further embodiments wherein an IIT is separated from a display by a physical barrier, for example by a visor, ballistic visor, or other type of armor.

Referring now to FIGS. 10 and 11, a first exemplary helmet system, first helmet system 300, is shown. The first helmet system includes a helmet shell 310, which in embodiments can include a ballistic shell, e.g., a helmet shell that provides protection from projectiles, or a non-ballistic, e.g., bump shell. The first helmet system 300 optionally includes a mandible guard 330 which in embodiments may include a ballistic or non-ballistic mandible guard, as is known in the art. An alternative embodiment of the first helmet system 300 does not include a mandible guard. The first helmet includes a remote-control module (RCM) 1900, described previously in relation to FIG. 3. In embodiments, the RCM 1900 may be mounted on a rear portion of the helmet shell 310, although it may be mounted on the helmet shell at another location.

The first helmet system 300 includes a visor 320 and a visor mount 340 for mounting the visor 320 on the helmet shell 310. The visor mount 340 may include any suitable apparatus for mounting a visor on a helmet shell, including a fixed-position visor and a movable visor, as is known in the art. The visor 320 includes an inner, user-facing, surface 325 and an outer, environment-facing, surface 327 opposing the inner surface. Embodiments of the visor 320 include a ballistic visor, e.g., a visor that provides protection from projectiles, or a non-ballistic visor. The visor 320 may include a clear, tinted, or opaque lens 323 and the lens may include one or more functional layers, for example one of more a hydrophobic layer, a defogging layer, a tint layer and a filter layer, as is known in the art. The visor lens 323 may be formed with a lens base including glass or a clear plastic, for example polycarbonate or acrylic. In a particular embodiment, the visor 320 is formed with an opaque ballistic protection material, for example including one or more of metal, aramid fiber, and ultra-high molecular weight polyethylene (UHMWPE), or other suitable ballistic protection materials as are known in the art.

The helmet system includes a viewing device, for example a first helmet-mounted display device 1360 mounted to the helmet shell 310 interior to the visor 320, e.g., between the visor and a user when the first helmet system 300 is worn by the user. In embodiments, the first helmet-mounted viewing device 1360 includes a display that is substantially similar to display 3000 disclosed previously herein, for example in relation to FIGS. 1, 6, and 7, disposed in a housing with mounting features suitable for attaching the first helmet-mounted display device to the helmet system 300. In embodiments, the first helmet-mounted display device 1360 includes a heads-up display (HUD) device, for example including a waveguide, or a viewing screen, for example an LED or OLED screen. The first helmet-mounted display device 1360 is disposed to be positioned within the line of sight of the user. In embodiments, the first helmet-mounted display device 1360 is a monocular viewing device that may be attached to a brim 312 of the helmet shell 310, as is known in the art, although the viewing device may be mounted at other locations, for example on another portion of the helmet shell 310, on the mandible guard 330, or attached to the visor 320. The first helmet-mounted display device 1360 may be electrically coupled to the RCM 1900 by an electrical conductor 317 for communicating power and data signals between the RCM and the viewing device.

The first helmet system 300 includes a first monocular helmet-mounted IIT 3001. The first helmet-mounted IIT 3001 is coupled to the helmet with an IIT attachment apparatus 345 which may be fixed or adjustable to allow positioning and repositioning of the first helmet-mounted monocular IIT 3001. In some embodiments, the first helmet-mounted IIT 3001 is mounted directly on the visor 320 and first helmet system may not include the ITT attachment apparatus 345.

The first helmet-mounted IIT 3001 may be mounted in line with the first helmet-mounted display device 1360, as illustrated, but need not be. In some embodiments the first helmet-mounted IIT 3001 is mounted above the first helmet-mounted display device 1360, for example above the visor 320 so as not to obscure viewing of a surrounding environment through the visor. Because the optical path between the first helmet-mounted IIT 3001 and the first helmet-mounted display device 1360 can be disjointed, i.e. non-aligned, the first helmet-mounted IIT 3001 is mounted may disposed at any suitable location on the first helmet system 301.

Referring to FIGS. 6, 7, 10, and 11, the first helmet-mounted IIT 3001 can include components of the fourth IIT 1106 or of the fifth IIT 1107. In embodiments, the first helmet-mounted IIT 3001 is substantially similar to one of the fourth IIT 1006 or the fifth IIT and functions in a substantially similar manner as the fourth IIT 1006 and fifth IIT, as disclosed previously herein. In either case, the first helmet-mounted IIT 3001 is configured to generate one or more of digital image data 1250 and augmented digital image data 1255 formatted for display on the first helmet-mounted display device 1360 and to communicate the image data to the first helmet-mounted display device 1360 through pass-through electronics 1560, and in some embodiments through one of more additional electrical conductors, represented by arrow 351. The pass-through electronics 1560 are substantially similar to pass-through electronics 1500, previously disclosed herein, and operate in a substantially similar manner to provide substantially similar functionality. The first helmet-mounted IIT 3001 further includes an instance of external electronics 1600 which is operable to communicate one or more of augmentation data 1635 and calibration data 1605 to the pass-through electronics 1560 and to communicate a copy of the digital image data to the RCM 1900, as disclosed previously herein, for example in relation to FIG. 3. In embodiments, the first helmet-mounted IIT 3001 is communicatively coupled to the RCM 1900 over the electrical conductor 317 for communicating data therebetween.

In exemplary embodiments, the first helmet-mounted display device 1360 includes a projector for projecting an image including the digital image data 1250 or augmented digital image data 1255. In these embodiments, a reflective diffractive grating 1367 may be formed on an inner surface 325 of a plastic or glass lens 323 with the viewing device 1360 positioned and disposed to project the image onto the diffractive grating 1367 such that a reflected version of the image is projected toward a user's eye or eyes. In embodiments, the viewing device 1350 may be disposed below a position of the diffractive grating 1367, for example on the mandible guard 330, or above the position of the diffractive grating 1367, for example on the helmet brim 312. In exemplary embodiments, the diffractive grating 1367 is formed and disposed to rotate an image, projected onto the diffractive grating by the viewing device 1360, 180 degrees to the user's eye, as is known in the art. In embodiments, the diffractive grating 1367 may be formed on the inner surface 325 of the lens 323 using an appropriate method, for example, an inkjet screen process, etching, laser ablation with appropriate screening, or by fastening a pre-formed diffractive grating the inner surface 325, for example using an optically clear adhesive.

In embodiments, one or more of the pass-through electronics 1560 and additional electrical conductors 351 are formed and disposed to traverse the visor 320. In a first exemplary embodiment, the pass-through electronics 1560 include electrical conductors embedded in or mounted on the visor 320, including, in one exemplary embodiment, optically transparent electrical conductors mounted on the visor, for example conductors formed from an optically transparent, electrically conductive material, for example indium tin oxide (ITO). The electrical conductors may extend from the first helmet-mounted monocular IIT 3001, along an outer surface 327 of the visor 320, to an interface of the visor with the helmet or to an electrical interface with the IIT mounting apparatus 345. The electrical conductors may be formed and disposed to traverse the visor 320, for example to pass from an outside surface of the visor to an inside surface of the visor across a thickness of the visor. In other embodiments, the electrical conductors may include one or more electrical cables extending between the first helmet-mounted monocular IIT 3001 and the display 1360, represented, for example, by arrow 351.

Referring to FIGS. 12 and 13, a second embodiment 302 and a third embodiments 303 of a helmet system are shown. Each of the second and third embodiments of a helmet system 302 and 303 include a helmet shell 310 and a visor 320. Each of the second and third embodiments can include two or more IITs, for example a second helmet mounted IIT 3003 and a third helmet mounted IIT 3005. Each of the second and third helmet-mounted IITs 3003 and 3005 is mounted on a first or second binocular mounting apparatus 3007 or 3009. The first binocular mounting apparatus 3007 and second binocular mounting apparatus 3009 may be attached to the helmet shell 310 with a same of different embodiment of an IIT attachment apparatus 345, as shown in FIG. 10. In an alternative embodiment, each of the first binocular mounting apparatus 3007 and the second binocular mounting apparatus 3009 are formed as multiple individual mounting features, one mounting feature corresponding to each of the first and second helmet mounted IIT 3003 and 3005 and each mounting feature may be coupled to the helmet shell 310 with a separate IIT attachment apparatus 345, thereby enabling individual manipulation and positioning of each of the first and second helmet mounted IITs 3003 and 3005.

Each of the second and third helmet mounted IITs 3003 and 3005 are substantially similar to the first monocular helmet mounted IIIT 3001, shown in FIGS. 10 and 11, and function to generate one or both of digital image data 1250 and augmented digital image data 1255, as previously described herein in relation to FIGS. 10 and 11. In embodiments, the second and third helmet systems 302 and 303 each include a second helmet-mounted display device 1363, associated with the second helmet-mounted IIT 3003, and a third helmet-mounted display device 1365, which is associated with the third helmet-mounted IIT 3005. Second helmet mounted pass-through electronics 1563, and in some embodiments additional electrical conductors 355, pass digital image data or augmented digital image data from the second helmet mounted IIT 3003 to the second helmet-mounted display device 1363. Third helmet mounted pass-through electronics 1565, and in some embodiments additional electrical conductors 357, pass digital image data or augmented digital image data from the second helmet mounted IIT 3005 to the second helmet-mounted display device 1365. The second helmet-mounted pass-through electronics 1563 and third helmet-mounted pass-through electronics 1565 can be configured and disposed in like manner, and function in a similar manner, as the first helmet-mounted pass-through electronics 1560, as described previously herein in relation to FIGS. 10 and 11. The second and third helmet-mounted display devices 1363 and 1365 may be configured and may be operable in a substantially similar manner as the first helmet-mounted display device 1360, as described previously herein in relation to FIGS. 10 and 11.

Each of the second and third helmet-mounted display device 1363 and 1365 are operable to display digital image data or augmented image data to a separate eye of a user, either by directly providing the image data to the user's eye or by directing a projected image toward one or more diffraction gratings, e.g., one or more instances of the diffraction grating 1367, described previously herein in relation to FIGS. 10 and 11, wherein the one or more diffraction gratings provide the image data to the user's eyes. In this manner, the second and third helmet systems 302 and 303 are configured and operable to provide binocular display of digital image data or enhanced image data to a user.

Referring now to FIG. 13, the third helmet system includes a first helmet-mounted daytime optics 3013 and a second helmet-mounted daytime optics 3017 disposed on the second binocular mounting apparatus 3009. A user can switch between operation of a helmet system 302 or 303 using helmet-mounted daytime optics 3013, 3017 and the helmet-mounted IITs 3003, 3005 depending on lighting conditions, for example by replacing one with the other, moving the helmet-mounted optics and helmet-mounted IITs relative to each other, or by selecting either the helmet-mounted daytime optics (3013, 3017) or the helmet-mounted IITs (2003, 3005) for activation, and electrically coupling the selected helmet-mounted optics or helmet-mounted IITs to corresponding helmet-mounted display devices 1363, 1365 without changing positions of the helmet-mounted optics or helmet-mounted IITs on the third helmet system 303.

Each of the first and second helmet-mounted daytime optics 3013 and 3017 includes an optic lens 1127 and an image sensor 1207. The image sensors 1207 are configured to generate digital image data, or augmented digital image data, for example corresponding to a bright or daylight environment, in similar manner as disclosed previously herein in relation to the daytime objectives 1127 disclosed herein in relation to FIG. 2B. When selected for use, the first helmet-mounted daytime optics 3013 are configured to provide, via pass-through electronics 1563, digital image data or augmented digital image data to the second helmet mounted display 1363 and the second helmet-mounted daytime optics 3017 are configured to provide, via pass-through electronics 1565, digital image data or augmented digital image data to the second helmet mounted display 1365. The arrangement shown in relationship to the third helmet 303 enables binocular display of both enhanced low light image data and of image data corresponding to brighter environments, e.g. corresponding to a daylight environment or to a well-lit interior or exterior night time environment while enabling a user to quickly and easily switch between daytime and nighttime viewing modes. This is particularly advantageous when a user moves between environments with different light levels since the user is enabled by the disclosed technology to rapidly switch viewing modes without needing to remove the imaging devices. Further embodiments of the second and third helmet systems can include more than two helmet mounted IITs, for example three or more helmet-mounted IITs. Digital image data or augmented digital image data communicated from each of the helmet-mounted IITs may be communicated to a separate helmet-mounted display device. In some alternative embodiments, a helmet system, e.g. 300, 302, or 303, may include fusion electronics 2100, see FIG. 2A, operable to fuse image data provided by two or more IITs for display on a single display device, for example on a helmet-mounted display device.

In an alterative embodiment, an arrangement of an IIT and a display device may be provided with the IIT disposed on one side of a structure and the display device disposed on the other side of the structure. For example, according to the inventive concepts depicted in FIG. 11.

Referring now to FIG. 14, a further embodiment of a system 400 according to the technology disclosed herein is shown schematically. The system 400 includes a barrier 390. In an embodiment, the barrier 390 may include armor, for example ballistic armor mounted on a vehicle. The barrier includes an inward facing surface 395, for example facing an interior of the vehicle, and an outward facing surface 397, for example facing an environment in which the vehicle is located. In other embodiment the barrier 390 may include a wall of an enclosure, for example of a building, of a boat hull, and airplane fuselage. The system 400 includes an instance of IIT 3001 with an instance of pass-through electronics 1560 mounted on or otherwise disposed to face outward from the outward facing surface 395 and a display device 1369 disposed on or otherwise disposed to face inward from the inward facing surface 395. The display device may include a display component that is substantially similar to display 1300, as disclosed previously herein, for example in relation to FIGS. 6 and 7. Electrical conductors 359 electrically connect the pass-through electronics 1560 to the display 1369. The IIT 3001 is configured and functions in a substantially similar manner as described in relation to FIGS. 6, 7, 10 and 11. The IIT 3001 generates digital image data or augmented digital image data corresponding to an outside environment relative to the barrier 390 and formatted for input to a display component, for example a LED or OLED screen of the display device 1369. The pass-through electronics 1560 and electrical conductors 359 communicate the digital data through the barrier 390 and to the display device 1369 without where the digital data are displayed without conversion.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

It will also be recognized by those skilled in the art that, while the invention has been described above in terms of preferred embodiments, it is not limited thereto. Various features and aspects of the above-described invention may be used individually or jointly. Further, although the invention has been described in the context of its implementation in a particular environment, and for particular applications (e.g. for helmet-mounted visors), those skilled in the art will recognize that its usefulness is not limited thereto and that the present invention can be beneficially utilized in any number of environments and implementations where it is desirable to clear condensed vapor from lenses or other surfaces. Accordingly, the claims set forth below should be construed in view of the full breadth and spirit of the invention as disclosed herein.

1. A digital imaging device comprising:
an image intensifier tube (IIT) configured to receive a scene image corresponding to an observed scene and to produce an enhanced image based upon the scene image;
a digital image sensor configured to receive the enhanced image and to generate digital image data corresponding to the enhanced image;
a digital display configured to receive the digital image data and to generate a displayed image corresponding to the digital image data; and
pass-through electronics configured to receive the digital image data from the digital image sensor and to provide the digital image data to the digital display without performing data conversion processing on the digital image data;
wherein the digital image sensor is configured to output the digital image data utilizing a same electrical interface as the digital display is configured to input.

2. The digital imaging device of claim 1, further comprising a first control clock, wherein:
a functional resolution of the digital image sensor is equal to a functional resolution of the digital display; and
the digital image sensor and the digital display both operate using the first control clock.

3. The digital imaging device of claim 1, wherein the pass-through electronics are configured to add information to the digital image data, wherein the information comprises one or more of color information, brightness information, calibration information, and augmented reality (AR) overlay information.

4. The digital imaging device of claim 3, wherein when the digital display is configured to display YUV color data and the digital image sensor is configured to generate a Y element of the YUV color data, the color information comprises a U element and a V element of the YUV color data.

5. The digital imaging device of claim 1, further comprising an external electronics processor in communication with the pass-through electronics;
wherein the pass-through electronics are configured to generate a copy of the digital image data and to provide the copy of the digital image data to the external electronics processor; and
wherein the external electronics processor is configured to determine:
one or more dark portions of the digital image data corresponding to one or more portions of the enhanced image having an absence of light;
one or more bright portions of digital image data corresponding to one or more portions of the enhanced image data having a brightness value corresponding to light; and
the pass-through electronics are configured to add the AR overlay information to the one or more dark portions of the digital image data and to add one or more of color and brightness information to the one or more bright portions of the digital image data.

6. The digital imaging device of claim 1 wherein the IIT comprises a photocathode, a microchannel plate (MCP), a power supply for providing power to the photocathode and to the MCP, a fiber optic plate, and a phosphor screen.

7. The digital imaging device of claim 6 wherein the digital image sensor comprises a CMOS sensor and the phosphor screen is deposited onto the CMOS sensor.

8. The digital imaging device of claim 1, wherein the digital image sensor is disposed on a first side of a circuit card, the digital display is disposed on a second side of the circuit card and the digital image sensor and the digital display are aligned along a shared axis.

9. The digital imaging device of claim 1, wherein:
the digital image sensor comprises an array of digital pixels, wherein a digital pixel of the array of digital pixels is configured to perform image sensing and analog-to-digital conversion of analog image data to generate the digital image data;
the digital image sensor comprises a sensor array comprising a plurality of sensor pixels, the sensor array comprising a plurality of rows of sensor pixels;
the digital display comprises a display array comprising a plurality of display pixels, the display array comprising a plurality of rows of display pixels;
the digital image sensor is configured to read out a first row of the plurality of rows of sensor pixels and to bin image data corresponding to the first row in to a first data packet; and
the digital display is configured to receive the first data packet and to fill a first row of display pixels with data comprising the first data packet, the first row of display pixels corresponding to the first row of sensor pixels.

10. The digital imaging device of claim 9, wherein:
the digital image sensor is further configured to, while reading out the first row of sensor pixels, read out a second row of the plurality of rows of sensor pixels and to bin image data corresponding to the second row in to a second data packet; and
the digital display is further configured to receive the second data packet and, while filling the first row of display pixels, to fill a second row of display pixels with data comprising the second data packet, the second row of display pixels corresponding to the second row of sensor pixels.

11. A digital imaging device comprising:
an image intensifier tube (IIT) configured to receive photons corresponding to a scene image and to produce enhanced photons corresponding to an enhanced version of the scene image;
a digital image sensor configured to receive the enhanced photons and to generate digital image data corresponding to the enhanced photons;
a digital display configured to receive the digital image data and to generate a displayed image corresponding to the digital image data;
wherein the digital image sensor is configured to output the digital image data formatted for consumption by the digital display without conversion.

12. The digital imaging device of claim 11, wherein:
the digital image sensor comprises a sensor array comprising a plurality of sensor pixels, the sensor array comprising a plurality of rows of sensor pixels;
the digital display comprises a display array comprising a plurality of display pixels, the display array comprising a plurality of rows of display pixels;
wherein the digital image sensor is configured to read out a first row and a second row of the plurality of rows of sensor pixels and to bin image data corresponding to the first row in a first data packet and image data corresponding to the second row in a second data packet; and
the digital display is configured to receive the first data packet and the second data packet and to;
fill a first row of display pixels with data comprising the first data packet, the first row of display pixels corresponding to the first row of sensor pixels; and
fill a second row of display pixels with data comprising the second data packet, the second row of display pixels corresponding to the second row of sensor pixels.

13. The digital imaging device of claim 11, wherein the IIT tube comprises the digital image sensor, the digital imaging device further comprising pass-through electronics disposed between the IIT tube and the digital image sensor for communicating the digital image data from the digital image sensor to the digital display.

14. The digital imaging device of claim 11, wherein the digital imaging device is configured to be mounted on a helmet system comprising a visor, the visor having an inner surface facing a wearer of the helmet system and an outer surface opposing the inner surface; wherein
the digital imaging device further comprising pass-through electronics disposed between the IIT tube and the digital image sensor; and
the IIT tube is disposed external to the outer surface; the display is disposed between the inner surface and the wearer, and the pass-through electronics communicate the digital image data between the outer surface and the inner surface.

15. The digital imaging device of claim 11, wherein:
the IIT is disposed on a first side of a barrier, the digital display is disposed on second side of the barrier, the first side opposing the second side, and wherein the pass-through electronics communicate the digital image data from the first side to the second side; and
the barrier comprises armor for resisting penetration by a ballistic projectile.
